(19) United States
(12) Patent Application Publication
(10) Pub. No.: US 2013/0097917 A1
(43) Pub. Date: Apr. 25, 2013

(54) Portable fly catcher

(71) Applicants: Yedidia Shofet, Los Angeles, CA (US); David Rahmany, Los Angeles, CA (US)

(72) Inventors: Yedidia Shofet, Los Angeles, CA (US); David Rahmany, Los Angeles, CA (US)

(21) Appl. No.: 13/317,458

(22) Filed: Oct. 19, 2011

(51) Int. Cl. A01M 3/00; A01M 3/04; A01M 5/02

(52) U.S. Cl. 43/107; 43/133; 43/114

(57) ABSTRACT

The Portable Fly Catcher is a new invention and is also an improvement on previous inventions that have the same claim. The unique design lends itself to the portability of the invention and the ease of use. It is designed to catch the fly or insect by luring it into the catch basket with the use of a natural pheromone that attracts the insect. Once the insect is inside you simply press the button and the window closes and captures the insect inside. You may release the insect later outside of your home or you have the option to place a sticky strip inside and trap the fly to throw the strip away at a later date. It gives the person using it the choice of releasing the insect or killing it with the strip.

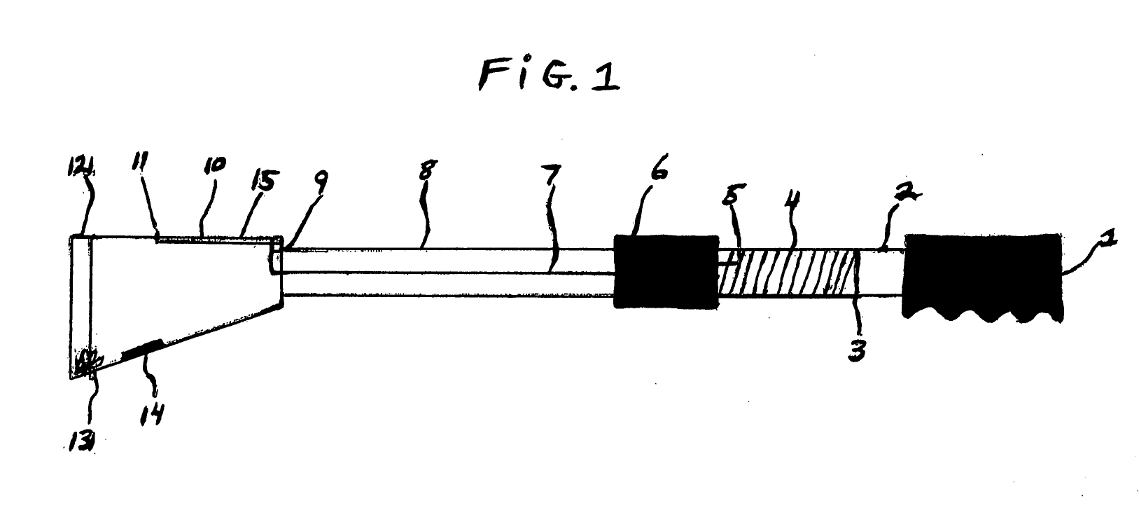

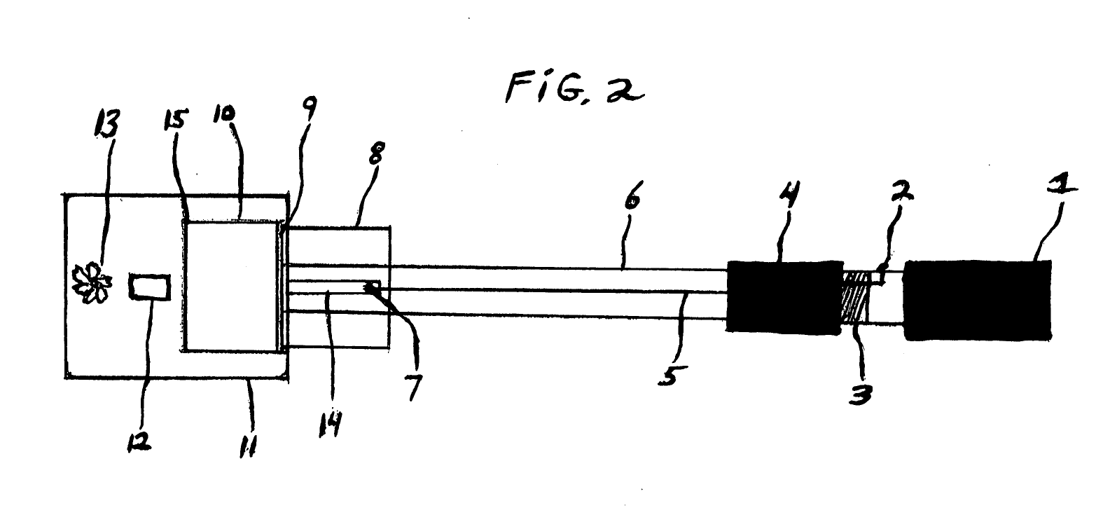

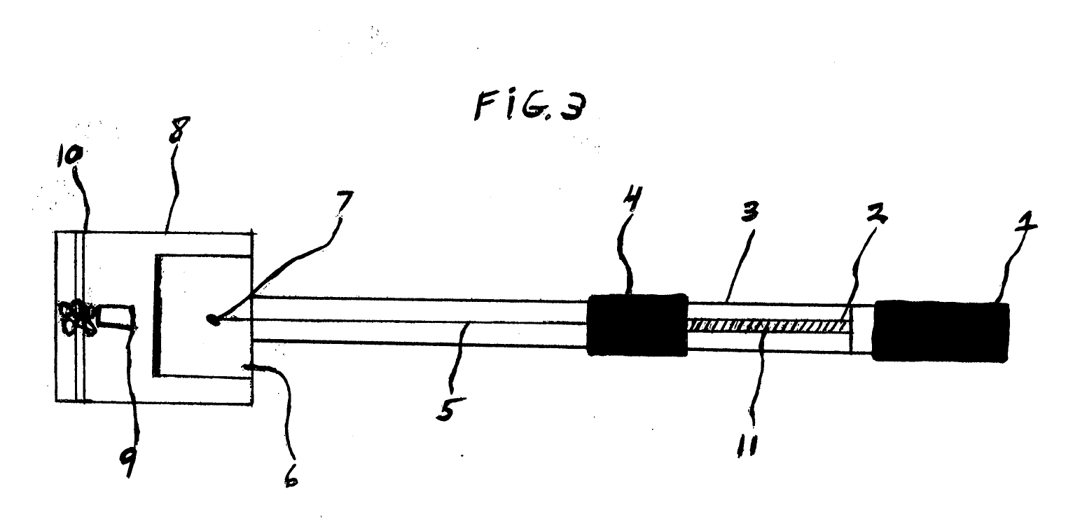

### BACKGROUND OF THE INVENTION

(1) Field of the Invention

The Portable Fly Catcher relates to and solves the problem with catching and or killing fly's and insects. It can simply catch the insect to release it later or it can capture the insect on a sticky strip and throw it away.

(2) Description of the Art Including Information Disclosed Under 37 CFR 1.97 & 1.98

The art described in the drawings of the design show that the invention is portable and has numerous parts both in its design and in its functionality.

### BRIEF SUMMARY OF THE INVENTION

The Portable Fly Catcher is a new invention and is also an improvement on previous inventions that have the same claim. The unique design lends itself to the portability of the invention and the ease of use. It is designed to catch the fly or insect by luring it into the catch basket with the use of a natural pheromone that attracts the insect. Once the insect is inside you simply press the button and the window closes and captures the insect inside. You may release the insect later outside of your home or you have the option to place a sticky strip inside and trap the fly to throw the strip away at a later date. It gives the person using it the choice of releasing the insect or killing it with the strip.

### BRIEF DESCRIPTION OF THE SEVERAL VIEWS OF THE DRAWINGS

There are 3 drawings in total that describe and illustrate the design and function of the “The Portable Fly Catcher”.

Diagram A: SIDE VIEW

Illustrations 1-15

#1 is the plastic or rubber handle

#2 is the hole for the button in illustration #5

#3 is the stop plate for the spring in illustration #4

#4 is the spring that is loaded with the handle #6 when pulled back

#5 is the metal or plastic part of the button that moves into position of illustration #2

#6 is the plastic or rubber loading handle that pulls the spring into position to be released by the button

#7 is the metal rod that attaches to the loading handle and to the window seal

#8 is the metal or plastic round or square hollow shaft that houses the rod, spring, and handles

#9 is the metal rod that attaches to the window seal

#10 is the channel to allow the window to slide back and forth

#11 is the seal attached to the basket body and the window

#12 is the body of basket which is made of a clear or opaque plastic

#13 is the plastic flower that holds the pheromone that attracts the insect

#14 is the optional sticky strip holder

#15 is the window that slides in and out

Diagram B: TOP VIEW

Illustrates 1-15

#1 is the plastic or rubber handle

#2 is the button now in position to be pressed and release the spring to close the window into position

#3 is the spring in a loaded position to be released by the button

#4 is the loading handle pulled back to press the spring into a loaded position

#5 is the metal rod attached to the window

#6 is the metal or plastic round or square hollow shaft that houses the rod, spring, and handles

#7 is the rod attachment to the window in the open position

#8 is the open window back into open position

#9 is the rubber stopper and seal attached to the window

#10 is the channel in the body of the basket

#11 is the body of the basket

#12 is the sticky strip holder

#13 is the flower that holds the pheromone that attracts the insect

#14 is the channel on the top side of the shaft to allow the rod and window to move back and forth

#15 is the rubber seal that attaches to the body of basket

Diagram C: BOTTOM VIEW

Illustrates 1-11

#1 is the handle

#2 is the spring inside the shaft and attached to the loading handle

#3 is the hollow shaft

#4 is the loading handle

#5 is the metal rod inside of the hollow shaft

#6 is the closed window

#7 is the rod attachment to the window

#8 is the body of the basket

#9 is the sticky strip holder inside the basket

#10 is the pheromone flower inside the basket

#11 is the channel on the bottom side of the shaft allowing the loading handle to slide the spring into a loaded position

### DETAILED DESCRIPTION OF THE INVENTION

The Portable Fly Catcher is held by the person using it and slides the loading handle back into a loaded position. By pressing the button on front of the handle they release the spring which pushed the metal rod forward which is attached to the window and the window then closes therefore sealing the body of the basket and preventing the fly or insect to escape. The invention can be used to release the insect later or to capture the in sect with the sticky strip and throw the strip away at a later time.

1. The Portable Fly Catcher offers an option in catching and releasing an insect or trapping it and killing it offering a clean and safe method in dealing with household fly's and insects.

2. It is portable and hand held and can be placed almost anywhere thereby using a pheromone to attract the insect into the basket and resting on the pheromone flower the person using it can press the release button and close the window to capture the insect.

3. The handle, shaft, loading handle, spring, basket, window, Pheromone flower, sticky strip, and button comprise the entire invention for portable use in catching an insect and having the option to release it or kill it.
